(19) United States
(12) Patent Application Publication
(10) Pub. No.: US 2010/0169792 A1
(43) Pub. Date: Jul. 1, 2010

(54) WEB AND VISUAL CONTENT INTERACTION ANALYTICS

(76) Inventors: Seif Ascar, Miami, FL (US); Ahmed A. Moussa, Dubai (AE)

Correspondence Address: KOKKA & BACKUS, PC, 200 PAGE MILL ROAD, SUITE 103, PALO ALTO, CA, 94306, US

(21) Appl. No.: 12/345,519

(22) Filed: Dec. 29, 2008

(51) Int. Cl. G06F 3/00

(52) U.S. Cl. 715/744

(57) ABSTRACT

Techniques for web and visual content interaction analytics are described, including capturing data associated with a web activity from one or more sources, the data including at least a video comprising eye-gaze data and the one or more sources comprising at least a visual imaging device configured to capture the video, initiating the capturing the data using an on-page module or script, transmitting the data comprising at least the video from the visual imaging device to a server configured to perform one or more transformations associated with the data, analyzing the data transmitted from the visual imaging device to the server to determine one or more values to generate an analytics report associated with the web activity and the one or more sources, and presenting the analytics report graphically on a display.

### FIELD

The present invention relates generally to software. More specifically, web and visual content interaction analytics is described.

### BACKGROUND

The layout, design and presentation of a website or visual content play an important role in the commercial effectiveness of a website or other visual content. A website usually hosts different types of content for user preview or serves as a searchable catalogue of multiple visual media asset types such as text, image, illustration and video content types. Often, the layout, design and presentation of a website or other visual content have a direct impact upon the marketability and profitability of the website or the visual content. In fact, the real value of a website or visual content is in the effectiveness of an actual user's engagement with the website or visual content. The ability to monitor actual user interactions while browsing and previewing a website or visual content provides insight into the functionality and effectiveness of the website or the visual content, its design, presentation, and other factors related to the commercial success or failure of the website or visual content. Based upon interpretation of collected data, dynamic changes or adjustments can be made to the design, layout, presentation, appearance, or functionality of a website or visual content to maximize the website's or the visual content's commercial or market viability. Some conventional solutions to track, measure, and analyze user interactions while navigating or previewing a website or visual content are limited in scope, cost-effectiveness and precision and typically result in inaccurate assumptions rather than actual measurements based on empirical study of user interactions with the website or visual content.

Some conventional solutions for web and visual content interaction analytics fail to accurately interpret a user's interactions. Conventional solutions rely upon a collection of limited data that does not directly correlate with a user's interaction with a website or visual content. Conventional techniques cannot reflect a user's interactions while the user has disengaged from active movement of the cursor or is not actively using an input device. Conventional techniques cannot provide accurate information related to a user's actual interaction with a website or visual content like reading, scanning through, eye browsing or pausing at any portion of the presented content. For example, conventional solutions used to evaluate user interaction only collect data related to cursor movements and input device functions, which does not accurately depict user interaction as often, a user will disengage from moving the cursor or hold the cursor still while actually viewing, looking at or scanning through several different locations on the web page or visual content. Conventional solutions do not have the ability to track, measure or analyze the varying interaction of all possible natural users. Conventional solutions prefer assigned test users rather than natural users. Conventional solutions rely on setting up centralized testing environments for a limited number of users mainly due to special hardware dependability or high cost of technology used. Conventional techniques are not able to accurately identify a distinct and unique user. Techniques presently utilized to identify a user fail to account for different users at the same computer terminal and cannot accurately distinguish between different users in a public access environment. Conventional techniques do not precisely reflect a distinct user's actual interaction with a website or visual content.

Thus, what is needed is a solution for web and visual content interaction analytics without the limitations of conventional techniques where an unlimited number of remote or centralized users can participate in testing and providing natural feedback of interaction data utilizing basic hardware and software. The collected data is then analyzed collectively to produce accurate and useful reports for the web or visual content owner.

### BRIEF DESCRIPTION OF THE DRAWINGS

Various embodiments of the invention are disclosed in the following detailed description and the accompanying drawings:

FIG. 1 illustrates an exemplary system configured to implement web and visual content interaction analytics;

FIG. 2 illustrates an exemplary system architecture configured to implement web and visual content interaction analytics;

FIG. 3 illustrates exemplary browsing data for web and visual content interaction analytics;

FIG. 4A illustrates an exemplary application architecture configured to implement web and visual content interaction analytics;

FIG. 4B illustrates an alternative exemplary application architecture configured to implement web and visual content interaction analytics;

FIG. 4C illustrates an alternative exemplary application architecture configured to implement web and visual content interaction analytics;

FIG. 4D illustrates an alternative exemplary application architecture configured to implement web and visual content interaction analytics;

FIG. 5A illustrates an exemplary process for web and visual content interaction analytics;

FIG. 5B illustrates an alternative exemplary process for web and visual content interaction analytics;

FIG. 6 illustrates another alternative exemplary process for web and visual content interaction analytics; and,

FIG. 7 illustrates an exemplary computer system suitable to implement web and visual content interaction analytics.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including but not limited to C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, and others. Design, publishing, and other types of applications such as Dreamweaver®, Shockwave®, Flash®, and Fireworks® may also be used to implement the described techniques. In other examples, the techniques used may also be a mix or a combination of more than one of the aforementioned techniques. The described techniques may be varied and are not limited to the examples or descriptions provided.

Techniques for web browsing analytics are described. As an example, web and visual content interaction analytics may be implemented to capture website or visual content catalogue browsing data (as used herein, “browsing data” and “interaction data” may be used interchangeably). In some examples, data to be analyzed may be retrieved from various sources including a web page, for example, (i.e., “browsing data”) or from a user interaction captured using, for example, a web camera (i.e., “web cam”) that generates or otherwise provides “interaction data” such as the geometric position of a user's eye when viewing a given website. In some examples, “browsing data” and “interaction data” may include information, statistics, or data related to some, any, or all activities associated with a given web page or a user's visual interaction with a given set of content (e.g., navigation actions, user eye movement and tracking when viewing a web page, and others). As used herein, “web activity,” and “web page or visual content catalogue navigation actions” may be used interchangeably to refer to any activity associated with web and/or visual content interaction activity. In other examples, “web activity” and “web page or visual content catalogue navigation actions” may include any or all actions, conduct or behaviors related to a user's interaction of an Internet website or visual content catalogue interaction while browsing, navigating, or viewing several different web pages or visual content catalogues. Web and visual content interaction analytics may be implemented while a natural user is on a website or visual content catalogue, or subject to a testing environment or conditions. Web and visual content interaction analytics may be executed from a website or can be downloaded onto a computer as software through the internet, or on a disc, and then executed on a machine. Examples of browsing data captured by web and visual content interaction analytics may include video or images of a user's facial features, eye-gaze movement, cursor navigation, cursor selection, elapsed time measurements, or other web and visual content interaction information related to a user's behavior or actions. As an example, a video of a user may be recorded through the user's own webcam or other visual imaging device while the user is actually browsing or navigating a website or visual content catalogue. In some examples, a “visual imaging device” may include an Internet camera, video recorder, webcam, or other video or image recorder that is configured to capture video data that may include, for example, eye-gaze data. As an example, “eye-gaze data” may include any type of data or information associated with a direction, movement, location, position, geometry, anatomical structure, pattern, or other aspect or characteristic of an eye. Web and visual content interaction analytics may implement an eye-gaze processor to transform the video data file or image data into values or coordinates representing the user's geometric eye position or motion (“eye-gaze”) and duration of the user's eye-gaze.

Alternatively, web and visual content interaction analytics may implement the eye-gaze processor to perform an identity verification of a user. In some examples, “identity verification” may refer to the identification of an individual, person, personae, user, or the like by resolving captured data to identify unique characteristics to that individual, person, personae, user, or the like. For example, identifying vascular patterns in a person's eye, iris, retina, facial structure, other facial features, eye geometry, or others may be used to perform identity verification. Data used for identity verification may, in some examples, include using video data captured describing or depicting facial features or geometry, and eye movement, motion, geometry, position, or other aspects. In other examples, “identity verification” may also refer to the use of biometric techniques to identify an individual using, for example, structural analysis and recognition techniques (e.g., facial, iris, retina, or other vascular structural definition or recognition functions). In still other examples, “identity verification” may also refer to the use or comparison of facial features or geometry to authenticate, verify, recognize or validate the identification of a user. As used herein “identity verification” may be also be referred to as facial recognition, eye authentication, facial verification, iris authentication, user authentication, user identification or others. In some examples, a user may be given an option to allow web browsing analytics to perform the identity verification. In other examples, the identity verification may be performed with or without obtaining explicit user consent. In other examples, identity verification may be varied and is not limited to the descriptions provided.

In some examples, an eye-gaze processor may be located on a central server or on a website client. If the eye-gaze processor module is located at a central server, the transmitted data related to the user's eye-gaze will be a video or digital image(s) file, suitable to be subject to further processing. If an eye-gaze processor is in the form of a client side program, the transmitted data related to the eye-gaze will be Cartesian coordinates indicating the location of the user's eye position or gaze (i.e., “eye-gaze”) on the website. After collecting the website browsing data, and possibly performing an intermediate processing of the video or digital image(s) file, both the data and the values may be transmitted to a central server to perform further analysis. At the central server, an analytics engine may be implemented to perform various analyses and generate a graphical output such as a heat map, time line, other charts or visual representations. The output may depict a user's actual interactions and accurately represent the duration the user viewed a particular portion of a web page or visual content while browsing or navigating a website or visual content catalogue. Web and visual content interaction analytics may provide useful, accurate and precise statistical data or representations of a user's interaction while browsing a website or visual content catalogue. The output may be displayed visually on a monitor, other display device or outputted to a data file. In other examples, web and visual content interaction analytics may be implemented differently and is not limited to the descriptions provided.

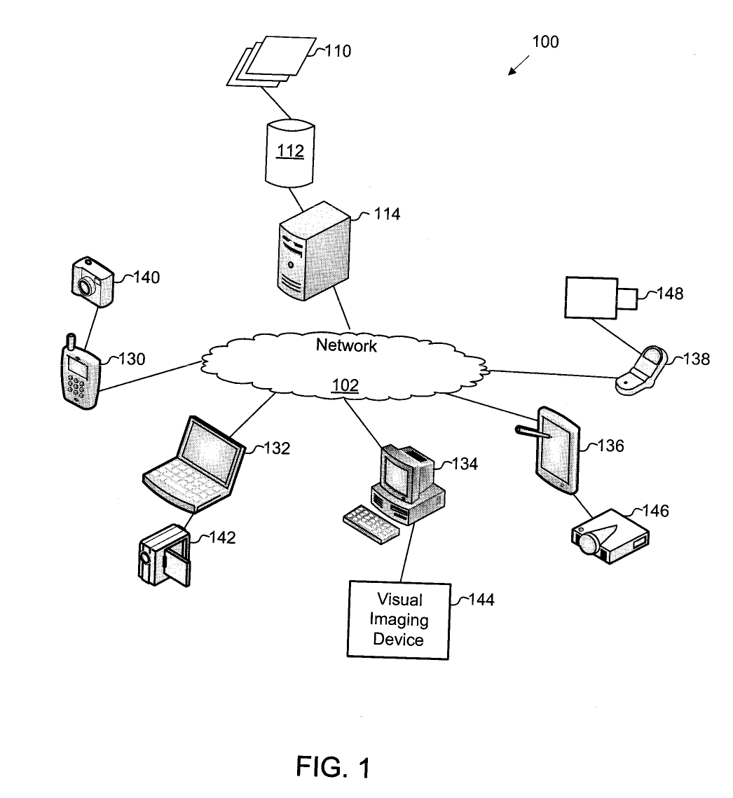

FIG. 1 illustrates an exemplary system configured to implement web and visual content interaction analytics. Here, system 100 includes network 102, data 110, database 112, server 114, clients 130-138, and visual imaging devices 140-148. In some examples, clients 130-138 may be wired, wireless, or mobile, and in data communication with server 114 using network 102. Network 102 may be any type of public or private data network or topology (e.g., the Internet, a local area network (LAN), a wide area network (WAN), a wireless local area network (WLAN), or any other type of data network or topology). Visual imaging devices 140-148 may be implemented using any type of image capture device such as those described herein. In some examples, server 114 may be implemented in data communication with database 112 and, using data 110, web and visual content interaction analytics may be implemented. In other examples, the number, type, configuration, and topology of system 100 including network 102, data 110, database 112, server 114, and clients 130-138 may be varied and are not limited to the descriptions provided.

For example, data 110 may include data generated or captured by any of clients 130-138 and transmitted (i.e., sent) to server 114 through network 102. In some examples, data 110 may include information associated with web activities or web page or visual content catalogue navigation actions (e.g., cursor navigation, cursor selection, time period measurements or other data). In still further examples, data 110 may include video or images captured by a visual imaging device. In other examples, system 100 and the above-described elements may be implemented differently and are not limited to the descriptions provided.

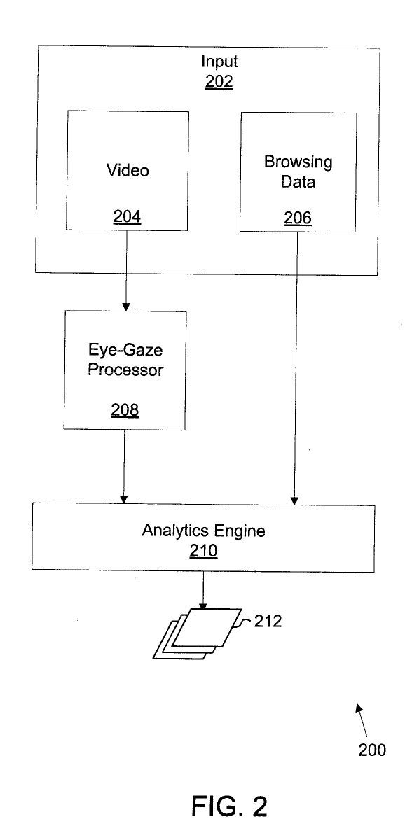

FIG. 2 illustrates an exemplary system architecture configured to implement web and visual content interaction analytics. Here, application 200 includes input 202, eye-gaze processor 208, analytics engine 210, and output 212. Still further, input 202 includes video/eye-gaze data 204 and browsing data 206. In some examples, “eye-gaze data” may include any type of data or information associated with a movement, location, position, geometry, anatomical structure, pattern, or other aspect or characteristic of an eye. In some examples, application 200 may be configured to transform data and manage data transmission over a data communication link or path (“data communication path”). In some examples, application 200 may be implemented as software code embedded within a website's or visual content catalogue's source code. In other examples, application 200 may be implemented as software, available to be downloaded from the internet or from a disc. Each of input 202, eye-gaze processor 208, analytics engine 210, and output 212 may be implemented as a computer program, application, software, hardware, circuitry, or a combination thereof. Further, input 202, eye-gaze processor 208, analytics engine 210, and output 212 may also be portions of software code that are discretely identified here for purposes of explanation. In other examples, application 200 and the above-described modules may be implemented differently are not limited to the features, functions, configuration, implementation, or structures as shown and described.

In some examples, input 202, including video/eye-gaze data 204 and browsing data 206, is generated by an end device or website while a user is navigating or browsing an internet web page or visual content catalogue. Further, input 202 may then be transmitted by a data communication path to analytics engine 210 for analysis, processing and transformation (i.e., conversion, manipulation or reduction of data to a different state). Before transmission to analytics engine 210, video/eye-gaze data 204 may be transmitted by data communication path to eye-gaze processor 208. Still further, eye-gaze processor 208 may be configured to transform video/eye-gaze data 204 from digital data associated with an image or video to values or coordinates associated with a geometric eye-gaze position, location or movement. Analytics engine 210 may be configured to process the values or coordinates associated with video/eye-gaze data 204 along with browsing data 206 to generate output 212. Still further yet, output 212 may be presented digitally on a display. In other examples, the modules may be implemented differently are not limited to the features, functions, configuration, implementation, or structures as shown and described.

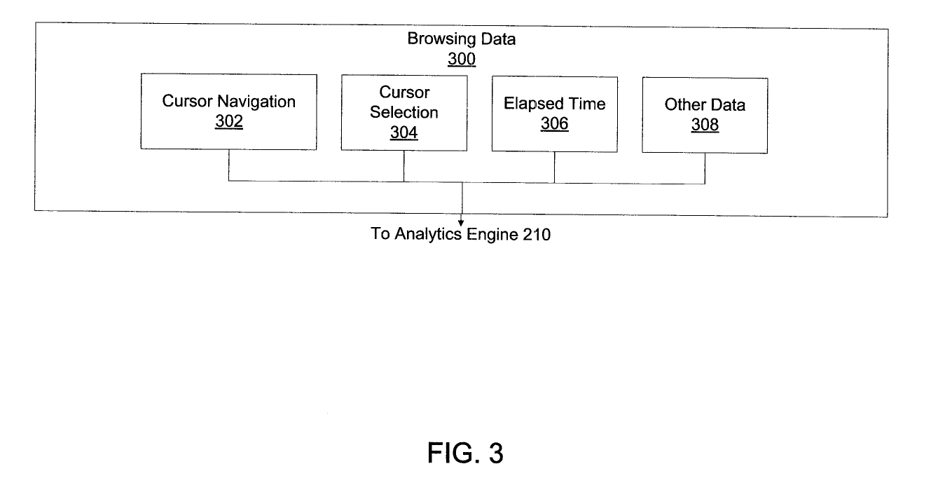

Here, input 202 includes video/eye-gaze data 204 and browsing data 206. In some examples, input 202 may be generated by any source, analog or digital, capable of recording, capturing or generating data, information, images, videos, audio or the like. For example, the source of input 202 may be any number of devices including a visual imaging device, audio recording device, picture capture device, image capture device, digital video recorder, digital audio recorder or the like. In other examples, the source of input 202 may be varied and is not limited to the examples provided. In some examples, video/eye-gaze data 204 may be eye-gaze data, a digital video or images captured or taken by a visual imaging device connected to a user's computer or end device, such as clients 130-138 (FIG. 1). Further, video/eye-gaze data 204 may be a video or images of the user, while the user is navigating, browsing, or interacting with a web page or visual content catalogue. In some examples, video/eye-gaze data 204 may be used to track the movement of the user's facial features, and particularly the user's eye movement, or used to perform identity verification (i.e., facial recognition, eye authentication, facial verification, iris authentication, user authentication, user identification) of the user. In other examples, browsing data 206 may be information related to the user's actions, also while the user is navigating, browsing or interacting with a web page or visual content catalogue (see FIG. 3 for further discussion regarding browsing data 206). Further, video/eye-gaze data 204 and browsing data 206 may be captured or generated simultaneously, in real time or substantially real time and subject to subsequent processing, analyzing, processing, evaluation and benchmarking. In other examples, input 202 may be generated or implemented differently and is not limited to the examples shown or described.

In some examples, eye-gaze processor 208 may be configured to transform video/eye-gaze data 204 from digital data related to an image or video to values or coordinates (e.g., Cartesian coordinates). The values or coordinates provide a geometric extraction of the direction, location, motion or position of a user's eye-gaze. Eye-gaze processor 208 may analyze, process, evaluate, or extract input 202 before transmission over a network, by data communication path, to a main server (e.g., server 114, FIG. 1) or after transmission over a network, by data communication path, to a main server. In other words, the implementation of eye-gaze processor 208 may be performed by client 130-138 (FIG. 1) or may be performed by server 114 (FIG. 1). In other examples, implementation of eye-gaze processor 208 may be different and is not limited to the examples as described.

In some examples, eye-gaze processor 208 may further be configured to process the video or images to perform an identity verification of the user. Eye-gaze processor 208 may record and identify particular facial features, or anatomical features of the user's eyes to calibrate and perform an identity verification of that user. For example, the ability to distinguish between several users may be useful to ensure an accurate separate and independent collection and analysis of each user's interaction and browsing history. Often times, many different users may have access to, or utilize a particular computer or browsing client. When computers are shared or provided in a public access environment, a user may intentionally, inadvertently, unknowingly or accidentally identify or name them self. In this example, the performance of an identity verification through the implementation of analyzing, processing or evaluating an image or video (as described previously) may ensure an accurate and correct identification of a user's identity. In other examples, eye-gaze processor 208 may be implemented and configured differently and is not limited to the examples shown or described.

In some examples, analytics engine 210 may be configured to receive input 202 directly from an end device (e.g., clients 130-138) or indirectly from an end device after intermediate processing by eye-gaze processor 208. Further, analytics engine 210 may be implemented to extract or transform input 202 to generate output 212. As an example, analytics engine 210 may be implemented to perform any number of qualitative processes to transform input 202 including a statistical analysis, an analysis of website or visual content catalogue metrics, benchmarking or other analysis. In some examples, a statistical analysis may be performed to determine patterns related to the user's behavior and interaction while navigating the website or visual content catalogue. Further, website or visual content catalogue metrics (i.e., the measure of a website's or visual content catalogue's performance) may be analyzed to determine a relationship between the function of the website or visual content catalogue and the user's navigation behavior. Still further, benchmarking may be performed to determine a level of website or visual content catalogue performance related to the user's interaction. In other examples, analytics engine 210 may be implemented to perform other processes to transform input 202 into output 212 and is not limited to the examples as shown or described.

In some examples, output 212 may be generated by analytics engine 210 using input 202. Some examples of output 212 may include an “analytics report” (e.g., any number of graphic depictions or interpretations of input 202 such as a report, chart, heat map, time line, graph, diagram or other visual depiction). As an example, output 212 may be configured to provide a visual representation of the user's behavior or actions while navigating and interacting with a website or visual content catalogue. Output 212 may visually represent the actual direction, location or position of a user's eye-gaze while navigating a web page or visual content catalogue, thereby providing an actual representation of the user's interaction with the web page or visual content catalogue. As an example, a heat map of a particular web page or visual content catalogue may be generated. In some examples, a “heat map” may be a graphical, visual, textual, numerical, or other type of data representation of activity on a given website, web page or visual content catalogue that provides, as an example, density patterns that may be interpreted. When interpreted, density patterns may reveal areas of user interest, disinterest, or the like to determine the efficiency of, for example, an online advertisement, editorial article, image, or other type of content presented on the website, web page or visual content catalogue. Heat maps may be used to track user activity on a given website, web page or visual content catalogue and, in some examples, utilize different colors or shades to represent the relative density of a user's interaction with the web page or visual content catalogue. The heat map may provide different colors, the different colors representing the relative time the user spent viewing a particular portion of the web page or visual content catalogue. For example, a red color may indicate that a user viewed or gazed at a particular portion of a website or visual content catalogue for a greater period of time than a location indicated by the color yellow. Therefore, the heat map may provide a visual depiction of the frequency, rate or occurrence of the user's eye-gaze location and movement and may not be limited to the color coding mentioned herein. In other examples, a time line may be created or developed that represents a lineal chronological depiction of a user's interaction with a particular web page or visual content catalogue. In other examples, the generation, depiction and presentation of output 212 may vary and is not limited to the examples as shown or described.

As an example, application 200 may be implemented to perform web and visual content interaction analytics. For example, a user may choose to navigate to a particular website or visual content catalogue on the internet or locally stored on a device. After accessing the start page or “home page” of the website or the visual content catalogue, the user may explicitly provide or grant consent (i.e., the user may be given an option to allow the website or visual content catalogue to record and generate input 202, or information related to the user's navigation of the website or visual content catalogue). In other examples, the user may not provide consent. Further, the user may activate a webcam to record video/eye-gaze data 204, or a series of images of their facial features, while interacting with the website. Video/eye-gaze data 204, or the images of the user, may be processed by eye-gaze processor 208 to generate values or coordinates associated with the location or position of the user's eye-gaze throughout finite time periods during the website and visual content interaction session. After processing by eye-gaze processor 208, the values or coordinates, along with browsing data 206 may be transmitted to analytics engine 210 for further transformation, analysis or processing. Analytics engine 210 may generate output 212, and output 212 may be displayed graphically or visually on a display. In other examples, application 200 may be implemented or configured differently and is not limited to the features, functions, configuration, implementation, or structures as shown and described.

FIG. 3 illustrates exemplary browsing data for web and visual content interaction analytics. Here, analytics engine 210, browsing data 300, cursor navigation 302, cursor selection 304, elapsed time 306 and other data 308 are shown. In some examples, analytics engine 210 and browsing data 300 may be respectively similar to or substantially similar in function and structure to analytics engine 210 and browsing data 206 as shown and described in FIG. 2. As shown here, browsing data 300 may include cursor navigation 302, cursor selection 304, elapsed time 306 and other data 308. As used herein, a “cursor” may refer to a pointer, arrow, marker or other indicator used on a computer screen or web page or visual content catalogue to allow a user to move around or navigate the computer screen or web page or visual content catalogue. In other examples, browsing data 300 may include different elements and is not limited to the examples or descriptions provided.

In some examples, browsing data 300 may include data related to web activities or web page or visual content catalogue navigation actions. In some examples, browsing data may include any data related to web activities or web page or visual content catalogue navigation actions other than the data associated with video/eye-gaze data 204 (FIG. 2). Browsing data 300 may represent a user's actions when browsing, viewing, navigating or otherwise utilizing an internet web page or visual content catalogue. Examples of browsing data 300 may include cursor navigation 302, cursor selection 304, elapsed time 306 or other data 308. In other examples, browsing data 300 may be any data related to web activities or behaviors which may be captured, recorded, generated or otherwise created by any source other than a visual imaging device. In some examples, cursor navigation 302 may represent the motion or movement of a cursor on a web page or visual content catalogue, as controlled or directed by a user. Cursor selection 304 may represent a user's decision to choose a selectable item contained on a web page or visual content catalogue, the user's selection guiding the operation and use of the web page or visual content catalogue. Elapsed time 306 may represent a time period measurement or time intervals related to a user's viewing, navigation, selection and utilization of a web page or visual content catalogue. Other data 308 may represent any other collectable data related to a user's interaction and use of a web page or visual content catalogue. In other examples, browsing data 300, cursor navigation 302, cursor selection 304, elapsed time 306 or other data 308 may be implemented differently and are not limited to the examples or descriptions provided.

In some examples, a user's behavior or conduct when utilizing a particular web page or visual content catalogue may be quantitatively measured when cursor navigation 302, cursor selection 304, elapsed time 306 and other data 308 associated with a single user are collectively gathered or generated. As an example, when accessing a website or visual content catalogue, a user is generally directed to a start page or “home page” or beginning location. The home page, and subsequent pages, will contain links, buttons, clickable images, navigational controls, trails, maps, bars or other types of selectable items that allow users to navigate around and through the website or visual content catalogue to access various levels of content. When viewing a web page or visual content catalogue a user may move a cursor around the page and select an item, thus directing the web page or the visual content catalogue in response to the user's selection. In this example, the user's actions can be measured through generation of browsing data 300, including cursor navigation 302, cursor selection 304 and elapsed time 306. Here, the user's control of the movement of the cursor around the web page or visual content catalogue may be the cursor navigation 302, the selection of a link, trail, map, or bar may be cursor selection 304 and the time taken to perform the aforementioned tasks may be elapsed time 306. In other examples, the aforementioned elements may be implemented differently and are not limited to the examples as shown and described.

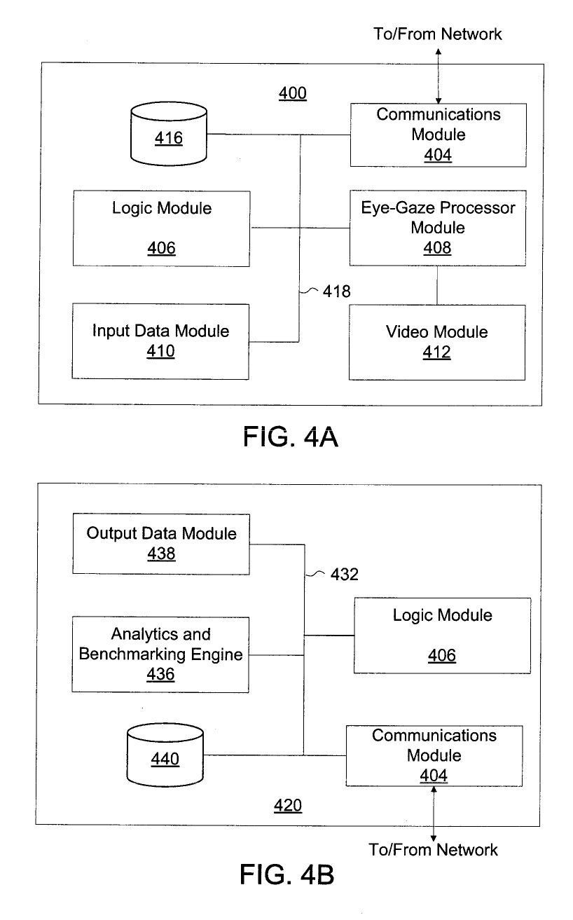

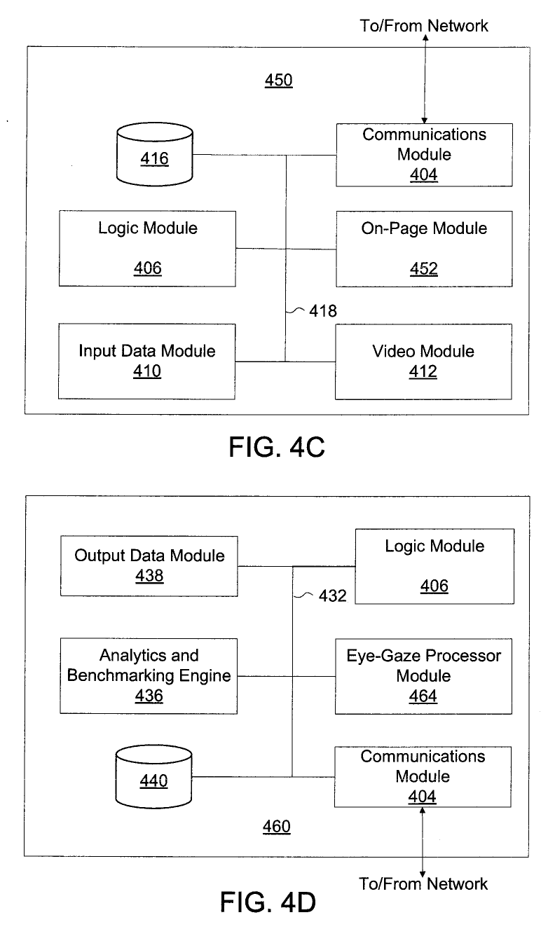

FIG. 4A illustrates an exemplary application architecture configured to implement web and visual content interaction analytics. Here, application 400, which may be implemented as hardware, software, or a combination thereof as, for example, a client application, includes communications module 404, logic module 406, eye-gaze processor module 408, input data module 410, video module 412, repository 416 and bus 418. Each of application 400, communications module 404, logic module 406, eye-gaze processor module 408, input data module 410, video module 412, repository 416 and bus 418 may be implemented as a computer program, application, software, hardware, circuitry, or a combination thereof. In some examples, repository 416 may be implemented as a database, data mart, data warehouse, storage area network (SAN), redundant array of independent disks (RAID), or other storage facility. In other examples, repository 416 may be implemented differently than as described above. In other examples, application 400 may be implemented differently and is not limited to the examples provided.

As shown here, communications module 404, in association with some, none, or all of logic module 406, input data module 410, video module 412, repository 416 and eye-gaze processor module 408, may be used to implement the described techniques. In some examples, video, images or data associated with web activities or web page or visual content catalogue navigation actions may be generated by a visual imaging device and transmitted to input data module 410 (via communications module 404) and interpreted by video module 412 in order to extract, for example, eye-gaze data for processing to eye-gaze processor module 408. In other examples, data (e.g., video data, eye-gaze data, and others) may be configured for transmission to logic module 406, or input data module 410 and may be stored as structured or unstructured data using repository 416. As described herein, logic module 406 may be configured to provide control signals for managing application 400 and the described elements (e.g., communications module 404, eye-gaze processor module 408, video module 412, input data module 410, repository 416, or others). Application 400, logic module 406, communications module 404, eye-gaze processor module 408, video module 412, input data module 410, and repository 416 may be implemented as a single, standalone application on, for example, a server, but also may be implemented partially or entirely on a client computer. In other examples, application 400 and the above-described elements (e.g., logic module 406, communications module 404, eye-gaze processor module 408, video module 412, input data module 410, and repository 416) may be implemented using client-server, peer-to-peer, distributed, web-based/SaaS (i.e., Software as a Service), or other type of topology, without limitation. In still other examples, one or more functions performed by application 400 or any of the elements described in FIGS. 4A-4D may be implemented partially or entirely using any type of application architecture, without limitation. In some examples, data generated by input data module 410 or video module 412 may be a parameter associated with web activities or web page or visual content catalogue navigation actions such as cursor navigation 302, cursor selection 304, elapsed time 306, other data 308 (as shown and described in FIG. 3), or video/eye-gaze data 204 (as shown and described in FIG. 2). In some examples, communications module 404 may be configured to be in data communication with input data module 410, video module 412, repository 416 and eye-gaze processor module 408 by generating and transmitting control signals and data over bus 418. In some examples, communications module 404 provides data input from and output to an operating system, server, network or other application configured to perform data analysis (e.g., web and visual content interaction analytics). As shown here, communications module 404 may be configured to receive, interpret, handle or otherwise manage input received from the Internet, network 102 (FIG. 1) or application 420 (FIG. 4B). In other examples, communications module 404 may be implemented differently and is not limited to the examples and descriptions provided.

As shown here, eye-gaze processor module 408 is located on application 420, which may be implemented as a component or module of functionality within an application that may be configured or implemented on a server, client, or other type of application architecture or topology. In some examples, eye-gaze processor module 408 may be implemented similarly or substantially similar in function and structure to eye-gaze processor 208 as shown and described in FIG. 2. In some examples, eye-gaze processor module 408 is implemented to process data generated by video module 412 before data is transmitted to another application by communications module 404. In other examples, application 420 may not include eye-gaze processor module 408. In other examples, eye-gaze processor 408 is implemented on another application and is not limited to the configurations as shown and described. In other examples, application 400 and the above-described modules may be implemented differently and are not limited to the order, features, functions, configuration, implementation, or structures provided.

FIG. 4B illustrates an alternative exemplary application architecture configured to implement web and visual content interaction analytics. Here, application 420, which may be implemented as hardware, software, or a combination thereof as, for example, a server application, includes logic module 406 (as described above in connection with FIG. 4A), bus 432, communications module 404, analytics and benchmarking engine 436, output data module 438, and repository 440. In some examples, application 420, bus 432, communications module 404, analytics and benchmarking engine 436, output data module 438, and repository 440 may be implemented as a computer program, application, software, hardware, circuitry, or a combination thereof. In some examples, repository 440 may be implemented as a database, data mart, data warehouse, storage area network (SAN), redundant array of independent disks (RAID), or other storage facility. In other examples, repository 440 may be implemented differently than as described. In other examples, application 420 may be implemented differently and is not limited to the examples provided.

As shown here, communications module 404, in association with some, none, or all of analytics and benchmarking engine 436, output data module 438, and repository 440 may be used to implement the described techniques. In some examples, communications module 404 may be configured to be in data communication with some, none, or all of analytics and benchmarking engine 436, output data module 438, and repository 440 by generating and transmitting control signals and data over bus 432. In some examples, communications module 404 provides data input from and output to an operating system, server, network or other application configured to perform data analysis (e.g., web and visual content interaction analytics). As shown here, communications module 404 may be configured to receive, interpret, handle or otherwise manage input received from the Internet, network 102 (FIG. 1) or application 400 (FIG. 4A). In other examples, communications module 404 may be implemented differently and is not limited to the examples and descriptions provided.

As shown here, analytics and benchmarking engine 436 is located on application 420, which may be implemented as a server, client, or other type of application. In some examples, analytics and benchmarking engine 436 may be implemented similarly or substantially similar in function and structure to analytics engine 210 as shown and described in FIG. 2. In some examples, analytics and benchmarking engine 436 may be implemented to analyze, evaluate, process or transform data generated by input data module 410 (FIG. 4A) or video module 412 (FIG. 4A) after data is received by communications module 404. Data analyzed by analytics and benchmarking engine 436, in some examples, may be retrieved, captured, requested, transferred, transmitted, or otherwise used from any type of data-generating source, including, for example, a visual image device, such as those described above. As used herein, analytics and benchmarking engine 436 may be configured to analyze data from any type of source, including eye-gaze data, which may be referred to as “all-in-one” analytics (i.e., analytics and benchmarking engine 436 may be configured, as a single functional module of application 420 that is configured to analyze data from any type of source). In other examples, analytics and benchmarking engine 436 may be implemented to analyze, evaluate, process or transform data previously processed by eye-gaze processor module 408. In other examples, analytics and benchmarking engine 436 may be implemented differently and is not limited to the examples as described and provided.

In some examples, data provided to communications module 404 may be a parameter or set of parameters associated with web activities or web page or visual content catalogue navigation actions such as cursor navigation 302, cursor selection 304, elapsed time 306 or other data 308 (as shown and described in FIG. 3) or video/eye-gaze data 204 (as shown and described in FIG. 2). As shown here, output data module 438 may be configured to receive, interpret, handle or otherwise manage data received from eye-gaze processor module 408 or analytics and benchmarking engine 436. In some examples, output data module 438 may be configured to generate output 212 (FIG. 2). In still further examples, output data module 438 may be configured to present output 212 graphically on a display. In other examples, output data module 438 may be implemented differently and is not limited to the examples described and provided.

As an example, application 400 (FIG. 4A) and application 420 may be configured to implement data capture and analysis. In some examples, application 400 may be configured to perform data capture and process data captured by eye-gaze processor 408. Further, application 420 may be configured to receive data from application 400 for processing, analysis and evaluation. For example, communications module 404 (as described above in connection with FIG. 4A) may be configured to receive data from application 400. Once received, data may be stored by repository 440 or processed, analyzed or evaluated by analytics and benchmarking engine 436. After processing, the data may be used by output data module 438 to generate and present an output 212. In other examples, application 420 and the above-described modules may be implemented differently and are not limited to the order, features, functions, configuration, implementation, or structures provided.

FIG. 4C illustrates an alternative exemplary application architecture configured to implement web and visual content interaction analytics. Here, application 450, which may be implemented as hardware, software, or a combination thereof as, for example, a client application, includes communications module 404, logic module 406, input data module 410, video module 412, repository 416, bus 418 and on-page module 452. In some examples, application 450 may additionally include an eye-gaze processor module (not shown) similar to or substantially similar in function and structure to eye-gaze processor 208 (FIG. 2). Each of application 450, communications module 404, logic module 406, input data module 410, video module 412, repository 416, bus 418 and on-page module 452 may be implemented as a computer program, application, software, hardware, circuitry, or a combination thereof. In some examples, repository 416 may be implemented as a database, data mart, data warehouse, storage area network (SAN), redundant array of independent disks (RAID), or other storage facility. In other examples, repository 416 may be implemented differently than as described above. In other examples, application 450 may be implemented differently and is not limited to the examples provided.

In some examples, on-page module 452 may be configured to initialize application 450. In some examples, on-page module 452 may be implemented as a web browser script (e.g., Java™, Javascript™, XML, HTML, HTTP, Flash and others). In other examples, on-page module 452 may be implemented as object or source code as part of an application that may be installed, executed, or otherwise run on, for example, a server, a client, or any other type of computer or processor-based device. As an example, on-page module 452 may be configured to generate and render an on-screen or displayed icon, widget, or other element (not shown) that, when selected or otherwise interacted with by a website user, initiates data capture by application 450. In some examples, on-page module 452 may also be configured to receive an input from an on-screen or displayed icon, widget, or other element indicative of consent from a website user for data capture, which may include video data capture (e.g., eye-gaze data, geometric or facial recognition data capture, or the like). After receiving consent, on-page module 452 may be configured to generate and transmit control signals to communications module 404. Communications module 404 may be configured to communicate with another application (e.g., application 460 (FIG. 4D)) to initiate transmission, receipt and handling of additional instructions, information, data or encoding necessary to analyze data gathered from web activities. As another example, after receiving consent (as described above), on-page module 452 may be implemented as a server, client, peer-to-peer, distributed, web servers, SaaS (i.e., software as a service), Flex™, or other type of application. In other examples, on-page module 452 may not be included in the source code of application 450, and application 450 may be implemented as software, available to be downloaded from the Internet, or downloaded from a computer readable medium (e.g., CD-ROM, DVD, diskette, or others). In other examples, on-page module 452 may be implemented differently and is not limited to the above-described examples as shown and provided.

In some examples, on-page module 452 may be configured to initialize data capture, generation or creation from, for example, a website or visual content catalogue using one or more of logic module 406, input data module 410, video module 412, and repository 416. Further, on-page module 452 may be configured to transmit data to or from a network (e.g., network 102 (FIG. 1)) using communications module 404. In some examples, application 450 may also include eye-gaze processor module 464 as described below in connection with FIG. 4D. In other examples, on-page module 452 may be implemented differently and is not limited to the examples as shown and described.

As shown here, communications module 404, in association with some, none, or all of logic module 406, input data module 410, video module 412, repository 416 and on-page module 452, may be used to implement the described techniques. In some examples, video, images or data associated with web activities or web page or visual content catalogue navigation actions may be generated by input data module 410 and video module 412. In other examples, the data may be configured for transmission using logic module 406, or input data module 410 and may be stored for transmission using repository 416. In some examples, data generated by input data module 410 or video module 412 may be a parameter associated with web activities or web page or visual content catalogue navigation actions such as cursor navigation 302, cursor selection 304, elapsed time 306, other data 308 (as shown and described in FIG. 3), or video/eye-gaze data 204 (as shown and described in FIG. 2). In some examples, communications module 404 may be configured to be in data communication with input data module 410, video module 412, repository 416 and on-page module 452 by generating and transmitting control signals and data over bus 418. In some examples, communications module 404 provides data input from and output to an operating system, server, network or other application configured to perform data analysis (e.g., web and visual content interaction analytics). As shown here, communications module 404 may be configured to receive, interpret, handle or otherwise manage input received from the Internet, network 102 (FIG. 1) or application 460 (FIG. 4D). In other examples, communications module 404 may be implemented differently and is not limited to the examples and descriptions provided. In other examples, application 450 and the above-described modules may be implemented differently and are not limited to the order, features, functions, configuration, implementation, or structures provided.

FIG. 4D illustrates an alternative exemplary application architecture configured to implement web and visual content interaction analytics. Here, application 460, which may be implemented as hardware, software, or a combination thereof as, for example, a server application, includes logic module 406 (as described above in connection with FIG. 4A), bus 432, communications module 404, analytics and benchmarking engine 436, output data module 438, repository 440, and eye-gaze processor module 464. In some examples, application 460, bus 432, communications module 404, analytics and benchmarking engine 436, output data module 438, repository 440, and eye-gaze processor module 464 may be implemented as a computer program, application, software, hardware, circuitry, or a combination thereof. In some examples, repository 440 may be implemented as a database, data mart, data warehouse, storage area network (SAN), redundant array of independent disks (RAID), or other storage facility. In other examples, repository 440 may be implemented differently than as described. In other examples, application 460 may be implemented differently and is not limited to the examples provided.

As shown here, communications module 404, in association with some, none, or all of analytics and benchmarking engine 436, output data module 438, repository 440, and eye-gaze processor module 464, may be used to implement the described techniques. In some examples, communications module 404 may be configured to be in data communication with some, none, or all of analytics and benchmarking engine 436, output data module 438, repository 440, and eye-gaze processor module 464 by generating and transmitting control signals and data over bus 432. In some examples, communications module 404 provides data input from and output to an operating system, server, network or other application configured to perform data analysis (e.g., web and visual content interaction analytics). As shown here, communications module 404 may be configured to receive, interpret, handle or otherwise manage input received from the Internet, network 102 (FIG. 1) or application 450 (FIG. 4C). In other examples, communications module 404 may be implemented differently and is not limited to the examples and descriptions provided.

As shown here, eye-gaze processor module 464 is located on application 460, which may be implemented as a server, client, or other type of application. In some examples, eye-gaze processor module 464 may be implemented similarly or substantially similar in function and structure to eye-gaze processor 208 as shown and described in FIG. 2. In some examples, eye-gaze processor module 464 is implemented to process data generated by video module 412 (FIG. 4C) after data is received by communications module 404. In other examples, application 460 may not include eye-gaze processor module 464. In other examples, eye-gaze processor 464 is implemented on another application and is not limited to the configurations as shown and described.

As shown here, analytics and benchmarking engine 436 is located on application 460, which may be implemented as a server, client, or other type of application. In some examples, analytics and benchmarking engine 436 may be implemented similarly or substantially similar in function and structure to analytics engine 210 as shown and described in FIG. 2. In some examples, analytics and benchmarking engine 436 may be implemented to analyze, evaluate, process or transform data generated by input data module 410 (FIG. 4C) or video module 412 (FIG. 4C) after data is received by communications module 404. In other examples, analytics and benchmarking engine 436 may be implemented to analyze, evaluate, process or transform data previously processed by eye-gaze processor module 464. In other examples, analytics and benchmarking engine 436 may be implemented differently and is not limited to the examples as described and provided.

In some examples, data provided to communications module 404 may be a parameter or set of parameters associated with web activities or web page or visual content catalogue navigation actions such as cursor navigation 302 (FIG. 3), cursor selection 304, elapsed time 306 or other data 308 (as shown and described in FIG. 3) or video/eye-gaze data 204 (as shown and described in FIG. 2). As shown here, output data module 438 may be configured to receive, interpret, handle or otherwise manage data received from eye-gaze processor module 464 or analytics and benchmarking engine 436. In some examples, output data module 438 may be configured to generate output 212 (FIG. 2). In still further examples, output data module 438 may be configured to present output 212 graphically on a display. In other examples, output data module 438 may be implemented differently and is not limited to the examples described and provided.

As an example, application 450 (FIG. 4C) and application 460 may be configured to implement data capture and analysis. In some examples, application 450 may be configured to initiate and perform data capture and application 460 may be configured to receive data from application 450 for processing, analysis and evaluation. For example, communications module 404 may receive data from application 450. Once received, data may be stored by repository 440 or processed, analyzed or evaluated by eye-gaze processor module 464 or analytics and benchmarking engine 436. After processing, the data may be used by output data module 438 to generate and present an output 212. In other examples, application 460 and the above-described modules may be implemented differently and are not limited to the order, features, functions, configuration, implementation, or structures provided.

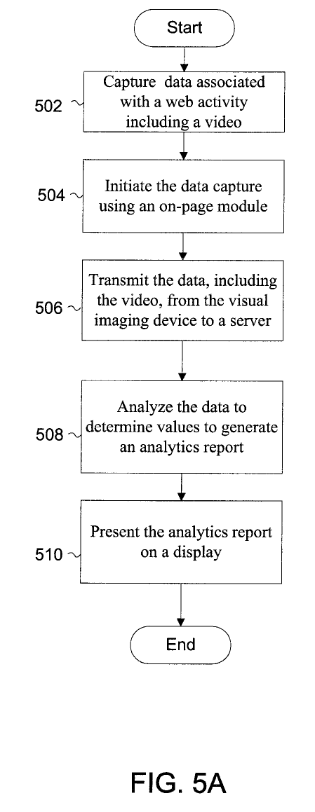

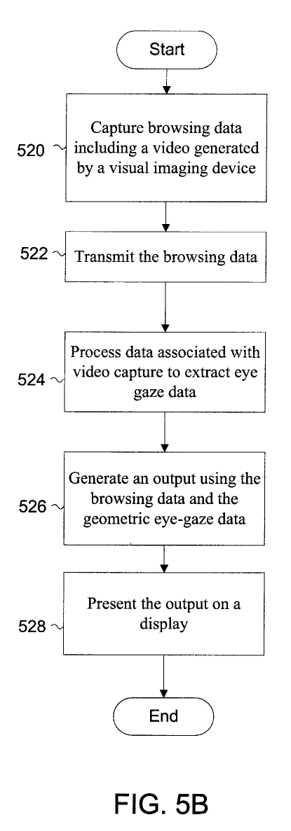

FIG. 5A illustrates an exemplary process for web and visual content interaction analytics. Here, data associated with a web activity may be captured from one or more sources. The data may include at least a video comprising eye-gaze data and the one or more sources may comprise at least a visual imaging device configured to capture the video (502). The data capture may be initiated using an on-page module script (504). The data comprising at least the video may be transmitted from the visual imaging device to a server configured to perform one or more transformations associated with the data (506). The data transmitted from the visual imaging device to the server may be analyzed to determine one or more values to generate an analytics report associated with the web activity and the one or more sources (508). The analytics report may be presented graphically on a display (510). The above-described process may be varied in function, processes and performed in any arbitrary order and is not limited to the examples shown and described.

FIG. 5B illustrates an alternative exemplary process for web and visual content interaction analytics. Here, browsing data associated with a web activity, including a video, may be captured by a visual imaging device (520). Once captured, the video may be transmitted from the visual imaging device to a processor configured to perform one or more transformations associated with the video (522). The browsing data associated with the video may be processed to extract eye-gaze data including one or more values representing a geometric eye position and motion (524). The values may be analyzed to generate an output using the geometric eye position and motion (526). The output may be presented graphically on a display (528). The above-described process may be varied in function, processes and performed in any arbitrary order and is not limited to the examples shown and described.

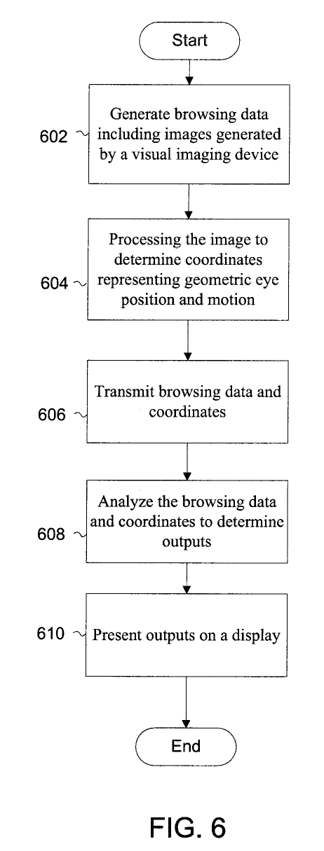

FIG. 6 illustrates another alternative exemplary process for web and visual content interaction analytics. Here, browsing data representing one or more web page or visual content catalogue navigation actions may be generated including one or more images generated by a visual imaging device (602). The one or more images may be processed to determine one or more coordinates representing a geometric eye-gaze position and motion (604). The browsing data and the one or more coordinates may be transmitted from the visual imaging device to an analytics engine. The analytics engine may be configured to perform one or more transformations associated with the browsing data and the one or more coordinates (606). The browsing data and the one or more coordinates may be analyzed to determine one or more outputs (608). The one or more outputs may be presented on a display (610). The above-described process may be varied in function, processes and performed in any arbitrary order and is not limited to the examples shown and described.

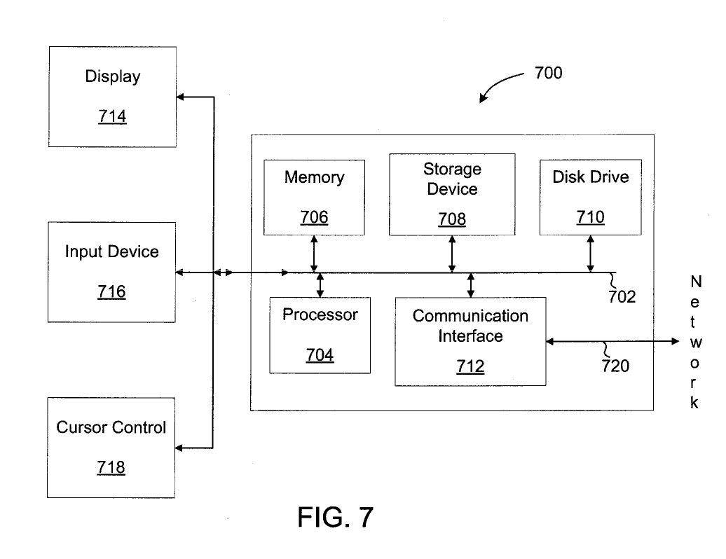

FIG. 7 illustrates an exemplary computer system suitable for web and visual content interaction analytics. In some examples, computer system 700 may be used to implement computer programs, applications, methods, processes, or other software to perform the above-described techniques. Computer system 700 includes a bus 702 or other communication mechanism for communicating information, which interconnects subsystems and devices, such as processor 704, system memory 706 (e.g., RAM), storage device 708 (e.g., ROM), disk drive 710 (e.g., magnetic or optical), communication interface 712 (e.g., modem or Ethernet card), display 714 (e.g., CRT or LCD), input device 716 (e.g., keyboard), and cursor control 718 (e.g., mouse or trackball).

According to some examples, computer system 700 performs specific operations by processor 704 executing one or more sequences of one or more instructions stored in system memory 706. Such instructions may be read into system memory 706 from another computer readable medium, such as static storage device 708 or disk drive 710. In some examples, hard-wired circuitry may be used in place of or in combination with software instructions for implementation.

The term “computer readable medium” refers to any tangible medium that participates in providing instructions to processor 704 for execution. Such a medium may take many forms, including but not limited to, non-volatile media and volatile media. Non-volatile media includes, for example, optical or magnetic disks, such as disk drive 710. Volatile media includes dynamic memory, such as system memory 706.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by a single computer system 700. According to some examples, two or more computer systems 700 coupled by communication link 720 (e.g., LAN, PSTN, or wireless network) may perform the sequence of instructions in coordination with one another. Computer system 700 may transmit and receive messages, data, and instructions, including program, i.e., application code, through communication link 720 and communication interface 712. Received program code may be executed by processor 704 as it is received, and/or stored in disk drive 710, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
capturing data associated with a web activity from one or more sources, the data including at least a video comprising eye-gaze data and the one or more sources comprising at least a visual imaging device configured to capture the video;
initiating the capturing the data using an on-page module or script;
transmitting the data comprising at least the video from the visual imaging device to a server configured to perform one or more transformations associated with the data;
analyzing the data transmitted from the visual imaging device to the server to determine one or more values to generate an analytics report associated with the web activity and the one or more sources; and
presenting the analytics report graphically on a display.

2. The method of claim 1, further comprising analyzing other data captured from sources apart from the visual imaging device.

3. The method of claim 1, wherein analyzing the eye-gaze data further comprises determining an identity verification.

4. The method of claim 1, further comprising performing a statistical analysis associated with the data and the one or more values.

5. The method of claim 1, further comprising analyzing metrics associated with the data and the one or more values.

6. The method of claim 1, wherein the data further comprises cursor navigation associated with the web activity.

7. The method of claim 1, wherein the data further comprises cursor selection associated with the web activity.

8. The method of claim 1, wherein the data further comprises time period measurements associated with the web activity.

9. The method of claim 1, wherein initiating the capturing the data using an on-page module is implemented using the script and, wherein the one or more sources comprises only eye-gaze data that is analyzed after being transmitted from the visual imaging device to the server.

10. The method of claim 1, wherein the output comprises a heat map.

11. The method of claim 1, wherein the output comprises a time line.

12. A method, comprising:
generating browsing data representing one or more web page or visual content catalogue navigation actions, the browsing data comprising at least one or more images generated by a visual imaging device;
processing the one or more images to determine one or more coordinates, the one or more coordinates representing a geometric eye-gaze direction, position and motion;
transmitting the browsing data and the one or more coordinates from the visual imaging device to an analytics engine configured to perform one or more transformations associated with the browsing data and the one or more coordinates;
analyzing the browsing data and the one or more coordinates to determine one or more outputs; and
presenting the one or more outputs on a display.

13. The method of claim 12, wherein processing the one or more images further comprises determining an identity verification.

14. The method of claim 12, further comprising performing a statistical analysis associated with the browsing data and the one or more coordinates.

15. The method of claim 12, further comprising analyzing metrics associated with the browsing data and the one or more coordinates.

16. The method of claim 12, further comprising determining one or more benchmarks associated with the browsing data.

17. The method of claim 12, wherein the one or more outputs comprises a heat map.

18. A system, comprising:
a memory configured to store data associated with a web activity and a logic module configured to capture data associated with the web activity from one or more sources, the data including at least a video comprising eye-gaze data and the one or more sources comprising at least a visual imaging device configured to capture the video, initiate the capture the data using an on-page module or script, transmit the data comprising at least the video from the visual imaging device to a server configured to perform one or more transformations associated with the data, analyze the data transmitted from the visual imaging device to the server to determine one or more values to generate an analytics report associated with the web activity and the one or more sources, and present the analytics report graphically on a display.

19. A system, comprising:
a memory configured to store browsing data associated with one or more web page or visual content catalogue navigation actions; and
a logic module configured to generate browsing data representing one or more web page or visual content catalogue navigation actions, the browsing data comprising at least one or more images generated by a visual imaging device, process the one or more images to determine one or more coordinates, the one or more coordinates representing a geometric eye-gaze direction, position and motion, transmit the browsing data and the one or more coordinates from the visual imaging device to an analytics engine configured to perform one or more transformations associated with the browsing data and the one or more coordinates, analyze the browsing data and the one or more coordinates to determine one or more outputs, and present the one or more outputs on a display.

20. A computer program product embodied in a computer readable medium and comprising computer instructions for:
capturing data associated with a web activity from one or more sources, the data including at least a video comprising eye-gaze data and the one or more sources comprising at least a visual imaging device configured to capture the video;
initiating the capturing the data using an on-page module or script;
transmitting the data comprising at least the video from the visual imaging device to a server configured to perform one or more transformations associated with the data;
analyzing the data transmitted from the visual imaging device to the server to determine one or more values to generate an analytics report associated with the web activity and the one or more sources; and
presenting the analytics report graphically on a display.

21. A computer program product embodied in a computer readable medium and comprising computer instructions for:
generating browsing data representing one or more web page or visual content catalogue navigation actions, the browsing data comprising at least one or more images generated by a visual imaging device;
processing the one or more images to determine one or more coordinates, the one or more coordinates representing a geometric eye-gaze direction, position and motion;
transmitting the browsing data and the one or more coordinates from the visual imaging device to an analytics engine configured to perform one or more transformations associated with the browsing data and the one or more coordinates;
analyzing the browsing data and the one or more coordinates to determine one or more outputs; and
presenting the one or more outputs on a display.
